(19) United States
(12) Patent Application Publication
(10) Pub. No.: US 2013/0025093 A1
(43) Pub. Date: Jan. 31, 2013

(54) Clip Assembly

(71) Applicant: Eric Liao, Taichung City (TW)

(72) Inventor: Eric Liao, Taichung City (TW)

(21) Appl. No.: 13/193,440

(22) Filed: Jul. 28, 2011

(51) Int. Cl. F16B 2/10

(52) U.S. Cl. 24/514

(57) ABSTRACT

A clip assembly includes a clip and a thumb screw mechanism. The clip includes two jaws each including two ends. The first end of the first jaw is connected to the first end of the second jaw. The thumb screw mechanism includes a bore defined in the first jaw, a screw extending into the bore from the second jaw, and a nut engaged with the screw. The nut includes a screw hole for receiving the screw, a first abutment unit for abutment against a side of the first jaw when the nut is rotated on the screw in a first direction and a second abutment unit for abutment against an opposite side of the first jaw when the nut is rotated on the screw in a second direction opposite to the first direction.

### BACKGROUND OF INVENTION

1. Field of Invention

The present invention relates to a clip and, more particularly, to a clip assembly including a clip and a combination of a screw with a nut.

2. Related Prior Art

As disclosed in U.S. Pat. No. 7,308,739, a conventional adjustable clip assembly includes a clip and a thumb screw mechanism 41 (FIG. 2), 72 (FIG.4) or 102 (FIG. 6). The clip includes two jaws 14 and 16 both extending from a hinge 22.

The thumb screw mechanism 41 includes a bore 44 defined in the jaw 14, a screw hole 48 defined in the jaw 16, a screw 42 inserted through the bore 44 and driven in the screw hole 48, and a knob 50 formed on the screw 42. The knob 50 is maneuvered to drive the screw 42 further into the screw hole 48 to cause the knob 50 to push the jaw 14 toward the jaw 16, thus closing the clip.

The thumb screw mechanism 72 includes a bore 80 defined in the jaw 14, another bore 82 defined in the jaw 16, a screw 74 inserted through the bores 80 and 82, a head 84 formed at an end of the screw 74, and a knob 76 made with a screw hole 90 for receiving the screw 74. The knob 76 is operated to drive the screw 74 further into the screw hole 90 to move the knob 76 toward the head 84 to push the jaw 14 toward the jaw 16, thus closing the clip.

The thumb screw mechanism 102 includes a screw hole 106 defined in the jaw 14, a bore 112 defined in the jaw 16, a screw 104 driven in the screw hole 48, a flange 108 formed at an end of the screw 104, and a boss 114 formed at an opposite end of the screw 104. The flange 108 is operated to drive the screw 104 further into the screw hole 106 to cause the boss 114 to push the jaw16 toward the jaw 14, thus closing the clip.

The thumb screw mechanism 41, 72 or 102 is only operated to close the clip. The thumb screw mechanism 41, 72 or 102 cannot be maneuvered to open the clip. Hence, it is impossible to open the clip wider than it is naturally by operating the thumb screw mechanism 41, 72 or 102.

The present invention is therefore intended to obviate or at least alleviate the problems encountered in prior art.

### SUMMARY OF INVENTION

It is the primary objective of the present invention to provide a clip and a thumb screw mechanism operable to open and close the clip.

To achieve the foregoing objective, the clip includes two jaws each including two ends. The first end of the first jaw is connected to the first end of the second jaw. The thumb screw mechanism includes a bore defined in the first jaw, a screw extending into the bore from the second jaw, and a nut engaged with the screw. The nut includes a screw hole for receiving the screw, a first abutment unit for abutment against a side of the first jaw when the nut is rotated on the screw in a first direction and a second abutment unit for abutment against an opposite side of the first jaw when the nut is rotated on the screw in a second direction opposite to the first direction.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is an exploded view of a clip assembly according to the preferred embodiment of the present invention;

FIG. 2 is a perspective view of the clip assembly shown in FIG. 1;

FIG. 3 is a cut-away view of the clip assembly shown in FIG. 1;

FIG. 4 is a cut-away view of the clip assembly in another position than shown in FIG. 3; and

FIG. 5 is a cut-away view of the clip assembly in another position than shown in FIG. 4.

### DETAILED DESCRIPTION OF PREFERRED EMBODIMENT

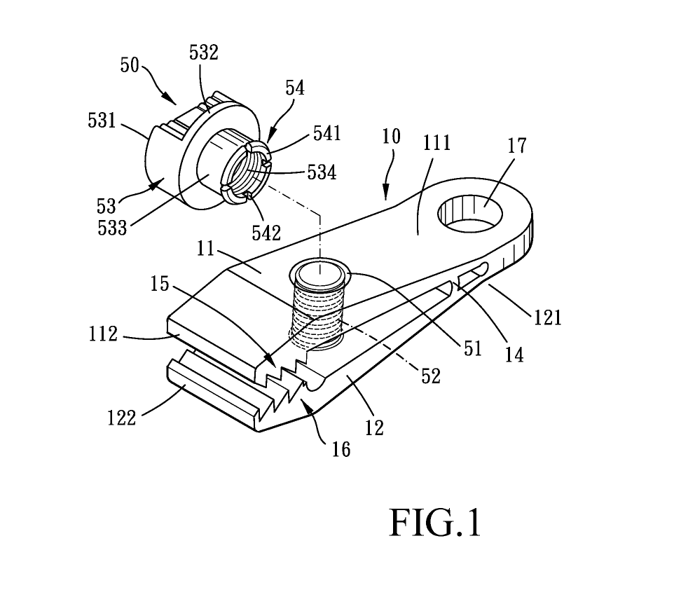

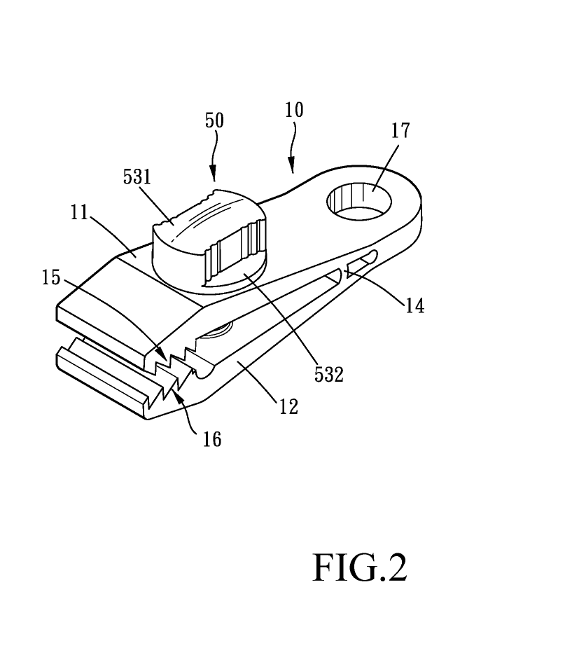

Referring to FIGS. 1 and 2, there is shown a clip assembly according to the preferred embodiment of the present invention. The clip assembly includes a clip 10 and a thumb screw mechanism 50.

The clip 10 is a V-shaped element including two jaws 11 and 12. The first jaw 11 is made with two opposite ends 111 and 112. The second jaw 12 is made with two opposite ends 121 and 122. The first end 111 of the first jaw 11 is connected to the first end 121 of the second jaw 12. Preferably, the first end 111 of the first jaw 11 and the first end 121 of the second jaw 12 are made one. The first and second jaws 11 and 12 are further interconnected by a connector 14 near the first ends 111 and 121. The connector 14 is a strip for reinforcing the clip 10 when the clip 10 is opened. The connector 14 includes a concave face 141 directed toward a mouth 13 defined between the second end 112 of the first jaw 11 and the second end 122 of the second jaw 12. The clip 10 further includes a bore 17 defined in a portion thereof near the first ends 111 and 121 of the first and second jaws 11 and 12.

The first jaw 11 includes a toothed face 15 formed thereon near the second end 112. The toothed face 15 includes teeth 151. The teeth 151 are preferably ratchets each including a vertical face and an inclined face 152 directed toward the mouth 13.

The second jaw 12 includes a toothed face 16 formed thereon near the second end 122. The toothed face 16 includes teeth 161. The teeth 161 are preferably ratchets each including a vertical face and an inclined face 162 directed toward the mouth 13.

The thumb screw mechanism 50 includes a bore 51 defined in the first jaw 11, a screw 52 extending into the bore 51 from the second jaw 12, and a nut 53 engaged with the screw 52. The bore 51 is a smooth bore, i.e., the wall of the bore 51 is smooth without any thread. The screw 52 includes a first end connected to the second jaw 12 and a second end inserted in the bore 51.

The nut 53 includes a knob 531, a first abutment unit 532, a sleeve 533, a screw hole 534 and a second abutment unit 54. The knob 531 is formed on a side of the first abutment unit 532. The knob 531 is used to facilitate rotation of the nut 53. The first abutment unit 532 is preferably a disc. The sleeve 533 is formed on an opposite side of the first abutment unit 532. The screw hole 534 is defined in the sleeve 533. The second abutment unit 54 includes an annular rib 541 formed on the sleeve 533 and slits 542 defined in the annular rib 541, thus dividing the annular rib 541 into several barbs. The flexibility of the annular rib 541 is increased by the slits 542. The annular rib 541 includes an upper side extending perpendicular to the periphery of the sleeve 533 and a chamfered lower side. The diameter of the annular rib 541 is larger than the diameter of the bore 51.

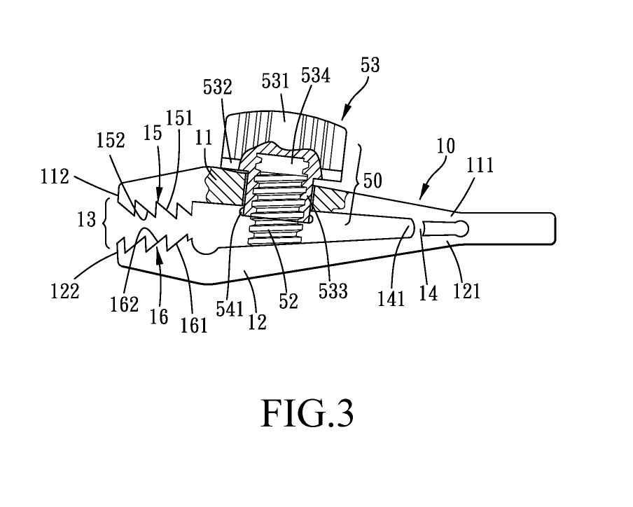

Referring to FIG. 3, to assemble the clip assembly, by rotating the nut 53 on the screw 52 in a first direction, the nut 53 is engaged with the screw 52, i.e., the screw 52 is inserted in the screw hole 534. Hence, the second abutment unit 54 is inserted in the bore 51. The insertion of the second abutment unit 54 in the bore 51 is allowed because of the chamfered lower side of the annular rib 541 and the slits 533. Eventually, the second abutment unit 54 is moved through the bore 51. Now, the second abutment unit 54 is located on a side of the first jaw 11 while the first abutment unit 532 is located on an opposite side of the first jaw 11.

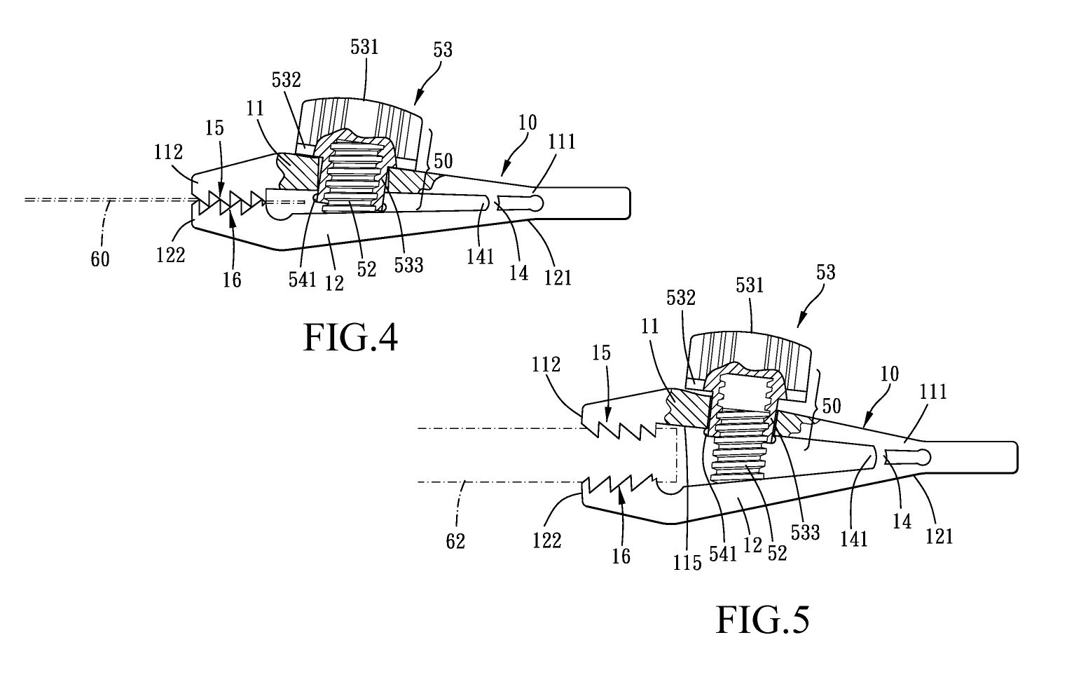

Referring to FIG. 4, in use, by further rotating the nut 53 on the screw 52 in the first direction, the screw 52 is inserted further into the screw hole 534, i.e., the first abutment unit 532 is moved toward the second jaw 12. As abutted against the first abutment unit 532, the first jaw 11 is moved toward the second jaw 12, thus closing the clip 10.

Referring to FIG. 5, by rotating the nut 53 on the screw 52 in a second direction opposite to the first direction, the screw 52 is moved away from the screw hole 534, i.e., the second abutment unit 54 is moved away from the second jaw 12. As abutted against the second abutment unit 54 and, more particularly, the upper side of the annular rib 541, the first jaw 11 is moved away from the second jaw 12, thus opening the clip 10.

Advantageously, the clip 10 is closed by rotating the nut 53 on the screw 52 in the first direction and opened by rotating the nut 53 on the screw 52 in the second direction. The operation of the clip assembly is convenient.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A clip assembly including:
a clip including first and second jaws each including first and second ends, wherein the first end of the first jaw is connected to the first end of the second jaw; and
a thumb screw mechanism including a bore defined in the first jaw, a screw extending into the bore from the second jaw, and a nut including:
a screw hole defined therein for receiving the screw;
a first abutment unit formed thereon for abutment against a side of the first jaw as the nut is rotated on the screw in a first direction; and
a second abutment unit formed thereon for abutment against an opposite side of the first jaw as the nut is rotated on the screw in a second direction opposite to the first direction.

2. The clip assembly according to claim 1, wherein the first abutment unit is a disc.

3. The clip assembly according to claim 2, wherein the nut includes a knob formed on a side of the first abutment unit.

4. The clip assembly according to claim 3, wherein the nut includes a sleeve formed on an opposite side of the first abutment unit, wherein the screw hole is defined in the sleeve.

5. The clip assembly according to claim 4, wherein the second abutment unit includes an annular rib formed on the sleeve.

6. The clip assembly according to claim 5, wherein the second abutment unit includes slits defined in the annular rib to increase the flexibility of the annular rib.

7. The clip assembly according to claim 1, wherein the clip includes a connector for connecting the first jaw to the second jaw near the first ends of the first and second jaws.

8. The clip assembly according to claim 1, wherein the connector is a strip extending from the first jaw to the second jaw.

9. The clip assembly according to claim 1, wherein the first jaw includes a toothed face formed thereon near the second end thereof, wherein the second jaw includes a toothed face formed thereon near the second end thereof.

10. The clip assembly according to claim 9, wherein the toothed face of each of the first and second jaws includes teeth.

11. The clip assembly according to claim 10, wherein the teeth are ratchets.

12. The clip assembly according to claim 11, wherein each of the ratchets includes an inclined face formed thereon and directed away from the first ends of the first and second jaws.
